(19) United States
(12) Patent Application Publication
(10) Pub. No.: US 2023/0264993 A1
(43) Pub. Date: Aug. 24, 2023

(54) METHOD AND SYSTEM FOR COMMINUTING AND CLEANING WASTE PLASTIC

(71) Applicant: Krones AG, Neutraubling (DE)

(72) Inventors: Michael RUSS, Straubing (DE); Franz BAUR, Regensburg (DE); Michael AUBURGER, Donaustauf (DE); Jochen FORSTHOEVEL, Regensburg (DE); Simon FISCHER, Regensburg (DE)

(21) Appl. No.: 18/165,878

(22) Filed: Feb. 7, 2023

(30) Foreign Application Priority Data
Feb. 21, 2022 (DE) 102022104008.9

(51) Int. Cl. C02F 3/06; B09B 3/35

(52) U.S. Cl. CPC C02F 3/06; B09B 3/35; C02F 2103/38

(57) ABSTRACT

A method and a system for comminuting and cleaning waste plastic are described. For this purpose, waste plastic is comminuted and pre-washed in a wet mill and then cleaned in a washing system. The resulting wastewater is subjected to mechanical filtration and flotation and then temporarily stored as circulating water. Based on this, some of the circulating water is returned to the wet mill as first process water and some of the circulating water is returned to the washing system as second process water. In this way, the first and second portions of the circulating water may be specifically adapted to the respective water requirements of the wet mill and the washing system as well as to the required water qualities, if necessary with selective post-cleaning of the second portion of the circulating water. As a result, the fresh water requirement for the process described may be minimized.

### CROSS REFERENCE TO RELATED APPLICATION

The present application claims priority to German Patent Application No. 102022104008.9 filed on Feb. 21, 2022. The entire contents of the above-listed application are hereby incorporated by reference for all purposes.

### TECHNICAL FIELD

The disclosure relates to a method and a system for comminuting and cleaning waste plastic.

### BACKGROUND

Such recycling processes and systems are usually based on comminution of waste plastics in wet mills with integrated pre-washing of the comminuted waste plastics, the subsequent cleaning thereof in multi-stage washing systems and final drying. Wet mills are usually supplied with fresh water for this purpose, which serves as process water for cooling the cutting/grinding tools used in the wet mills, supports the grinding process as such, and also washes off and absorbs dirt carried in by the waste plastic. Fresh water is also used as process water in the associated washing systems in order to absorb dirt adhering to the surface of the comminuted old plastic and any micro-plastics generated during comminution. Process water contaminated in this way is discharged as wastewater and usually fed into the sewer system.

The contaminant load of wastewater generated in this way, however, may be so high that it cannot be discharged into a public sewer system without further treatment. In principle, fresh water may be added as a makeshift in order to meet the respective local requirements by dilution. This causes, however, an enormous fresh water demand, which should be minimized both for cost reasons and in favor of environmental protection.

In addition, the wastewater from PET recycling systems is often still contaminated with very small plastic particles despite mechanical filtration before discharge into the public wastewater network. It would therefore be desirable, for example, to minimize the (residual) content of microplastics in the wastewater produced.

Therefore, there is a need for improved methods and systems for comminuting and cleaning used plastics, in particular with a reduction in fresh water requirements.

### SUMMARY

The object posed is solved with a method according to claim 1 and with a system according to claim 8. Advantageous embodiments are indicated in the dependent claims.

Accordingly, the method is used for comminuting and cleaning used plastic, which is comminuted and prewashed for this purpose in a wet mill and then cleaned in a washing system, in particular in a multistage resource-preserving manner. The resulting wastewater is treated by mechanical filtration and flotation and then temporarily stored as circulating water. Based on this, a first portion of the circulating water is fed back to the wet mill as a first process water and a second portion of the circulating water is fed back to the washing system as a second process water.

In this way, a water circuit/cycle may be provided, in which the process water used to clean the used plastic is continuously freed from the dirt it has absorbed and is fed back into the comminution process and washing process. As a result, the discharge of contaminated wastewater into a public sewer system, which is restricted by environmental regulations and incurs high costs, may be largely avoided, and fresh water requirements may be minimized. The dirt carried in by the used plastic may be removed/discharged in concentrated form, for example as dewatered and/or dried sludge, by means of separation systems integrated in the water circuit/cycle. Subsequent disposal of the dirt separated in this way is comparatively simple and inexpensive.

By selectively feeding the first and second portions of the circulating water to the wet mill and to the washing system, the dirt load resulting there in each of the individual washing processes may be controlled, for example so as to avoid an excessive increase in the specific dirt load in a particular cleaning stage and/or the associated wastewater.

On the one hand, the treatment of the wastewater for reuse as process water in the wet mill and in the washing system is feasible for the two portions of the circulating water together, for example in a first treatment stage, in order to produce a minimum water quality there that is usually required in the wet mill. On the other hand, however, separate treatment is also feasible, in particular for the second portion, in order to improve its water quality, which is often required for reuse in the washing system. The second process water has to be particularly clean, for example, for the production of recyclate for food production, and has then essentially to be of fresh water quality.

Thus, an overall environmentally friendly system operation with minimal resource consumption and comparatively low operating costs may be achieved.

The wet mill operates with an internal process water circuit, in which the process water continuously flows through the grinding chamber of the wet mill. This serves to optimize the grinding result, to cool the cutting/grinding tools and to pre-wash the material to be ground, i.e. the comminuted waste plastic. In the method described, the wet mill establishes the first contact of the waste plastic to be processed with process water.

The largest quantitative portion of the contaminants of the old plastic and/or the grinding dust produced, expressed for example as chemical oxygen demand and/or solids content, is already absorbed by the first process water flowing through the wet mill, which then leaves the wet mill as wastewater. The contaminant load of this wastewater may be reduced in the described cycle to a residual contaminant load permissible for reuse either as the first process water in the wet mill or as the second process water in the washing system.

The washing system is used for deep cleaning of the ground material produced in a resource-preserving manner by removing surface contaminants and/or microplastics that may have been generated during grinding. The ground material (the comminuted used plastic) is present at the exit of the wet mill in the form of so-called flakes and then preferably passes through several washing zones/cleaning stages of the washing system (washing cascade), in which different cleaning media and temperatures may be applied. The second process water (wash water) required for this purpose is preferably supplied in the final cleaning stage of the washing system, which is used for post-cleaning (post-washing), and then passes through upstream cleaning stages, for example for pre-cleaning (pre-washing) and main cleaning (main washing) in counter-current to the comminuted waste plastic (flakes). The contaminated second process water is then also discharged as wastewater.

Resource-preserving cleaning means that the used plastic is neither chemically nor thermoplastically changed, but merely mechanically comminuted, for example into so-called flakes.

The first process water and the second process water having a lower contaminant load are combined as wastewater and initially treated together. This initial treatment in a first treatment stage includes both mechanical filtration, for example by means of a sand separator and/or a fine screen, and subsequent flotation treatment, preferably by means of dissolved air flotation.

The resulting circulating water generally always meets the requirements for the first process water for reuse in the wet mill. Depending on the type and amount of dirt carried in by the waste plastic and depending on the intended use of the recyclate to be produced, the quality of the circulating water treated in this way may in principle be suitable for reuse as the second process water in the washing system without the need for post purification.

Mechanical filtration may be based, for example, on the principle of a cyclone or centrifuge and is preferably supplemented by a fine screen to separate sand and other solids from the wastewater.

Flotation may be used to remove suspended ingredients, such as oil or solids, from the wastewater, preferably based on the principle of dissolved air flotation.

After flotation, the chemical oxygen demand (COD) of the effluent, i.e. the circulating water, is reduced by, for example, 60 to 80% compared to the feed wastewater, the solids content by, for example, at least 95% and/or the content of fats, oils and lubricants by at least 95%. After decanting the sludge produced during flotation, its solids content may be increased to up to 30%, in particular to 20-30%, for example, by centrifuging the sludge and/or pressing the sludge in a screw press. The flotation stage is therefore preferably associated with a centrifuge. Consequently, the sludge thus dewatered may be disposed of separately in an efficient manner.

Preferably, the second portion of the circulating water is post-purified by a combination of biodegradation and membrane filtration or by electrocoagulation. Biodegradation and membrane filtration are known to take place in a so-called membrane bioreactor and serve to remove organic components of the wastewater and inorganic nutrients, for example nitrogen compounds, from the wastewater and convert them into a bioactive sludge. Membrane filtration is preferably performed separately in the form of ultrafiltration to effectively reduce chemical oxygen demand, biochemical oxygen demand, nitrogen content and microplastic content.

Thus, the quality of the second portion of the circulating water may be specifically adapted to the higher requirements in this respect for use as second process water in the washing system, compared to the lower quality requirements in this respect for use of the first portion of the circulating water as first process water in the wet mill.

A combination of biodegradation and membrane filtration thus primarily serves to reduce the chemical oxygen demand when the wastewater is comparatively heavily contaminated with oil. Electrocoagulation may be used as a substitute, in particular provided that there are no quality requirements for the production of recyclate for food applications in the washing system.

In a further favorable embodiment, the second portion of the circulating water is post-cleaned by reverse osmosis further, in particular to a water quality suitable for food processing. Reverse osmosis may be used to maximize the water quality, but this reduces the amount of the second portion of the circulating water remaining thereafter by up to one-third. Reverse osmosis minimizes the chemical oxygen demand and the nitrogen and phosphorus content of the second portion of the circulating water to achieve essentially fresh water quality.

Preferably, the first portion of the circulating water is adjusted to at least twice the quantity, in particular three to six times the quantity of the second portion. This allows the respective requirements for first process water and second process water to be covered for most applications and process conditions. Furthermore, the treatment stages that may be present for post-cleaning of the second portion of the circulating water may be utilized and operated in an economical manner.

In a further favorable embodiment, external fresh water is fed to the washing system in addition to the second process water and, in the process, the ratio of the second process water fed to the external fresh water is set to at least 1 and, in particular, to 1.5 to 5. This enables compensation for water losses generated by the treatment of the second portion of the circulating water and by evaporation in the washing system or the like without deteriorating the quality of the second process water.

In a further favorable embodiment, the chemical oxygen demand (COD) in the second portion of the circulating water is at least halved, preferably reduced to at most one third, by the post-cleaning compared to the first portion of the circulating water. Preferably, the chemical oxygen demand in the second portion is then only at most 1000 mg/l. For example, the chemical oxygen demand (COD) in the first portion of the circulating water is 2000 to 4000 mg/l and, in contrast, is reduced to 1000 to 2000 mg/l or less in the second portion by the post-cleaning. In this way, the water quality of the first and second process water may be specifically adjusted to the respective requirements in the wet mill and in the washing system for most applications and with regard to economical system operation.

In the method described, cutting/grinding tools present in the wet mill and the waste plastic comminuted therewith are preferably exposed to the first process water in such a way that it absorbs a proportion of the contaminant load present on the waste plastic, in particular its main proportion, and is then fed to mechanical filtration and flotation, in particular completely as wastewater. This provides an effective pre-wash of the used plastic, so that only superficially adhering residual contamination needs to be removed in the subsequent washing system.

The main portion of the contaminant load present on the waste plastic may be quantified, for example, by the fact that at least 50% of the chemical oxygen demand and/or solids content introduced by the waste plastic (per unit volume of the first process water supplied) passes into the waste water of the wet mill and is thus not introduced into the washing system.

In a favorable embodiment, a third portion of the circulating water, which has been mechanically cleaned at least by filtration and flotation/decantation, is treated chemically and/or enzymatically to thereby break down minute plastic particles contained in the circulating water, the third portion is discharged as wastewater, in particular as a result of wastewater separation during membrane filtration, electrocoagulation and/or reverse osmosis of the second portion of the circulating water. Thereby, the loading of the wastewater to be discharged from the process/device with microplastics may be reduced.

The described enzymatic and/or chemical degradation of plastic microparticles, for example of PET microparticles up to 200 μm particle size, is based, for example, on a biocatalytic depolymerization of the plastic, in particular PET, by means of microbial polyester dehydrolases or similar enzymes.

The described recycling system is used for comminuting and cleaning waste plastic and includes for this purpose: a wet mill for comminuting and pre-washing the waste plastic; a washing system, in particular a multistage washing system, for subsequent resource-preserving cleaning of the comminuted waste plastic; a mechanical filtration stage and a flotation stage for treating wastewater from the wet mill and the washing system to form circulating water; a buffer tank for intermediate storage of the circulating water; and, connected thereto, a first circulation circuit for returning a first portion of the circulating water to the wet mill for use there as first process water and a second circulation circuit for returning a second portion of the circulating water to the washing system for use there as second process water. Thus, the advantages described with respect to claim 1 may be achieved.

Preferably, the second circulation circuit includes a membrane bioreactor or an electrocoagulation stage and, in particular, further includes a respective downstream reverse osmosis stage. Thus, the water quality may be specifically adapted depending on the requirements for the second process water in the washing system, for example for the production of plastic recyclate for the food industry, as described with respect to the method.

Preferably, the circulation circuits are connected to the buffer tank and configured to convey the circulating water in such a way that its first portion may be set to be at least twice as large as its second portion, in particular at least three to six times as large. For this purpose, for example, separately controllable pumps are provided in the first and second circulation circuits.

Preferably, the membrane bioreactor includes an aerobic biodegradation stage and a separate ultrafiltration stage.

Preferably, the mechanical filtration stage includes a sand separator, a fine screen and/or a tank for filtered wastewater. The sand separator may, for example, be a cyclone or otherwise operate on the principle of gravitational separation. The fine screen, for example, has a mesh size of 200 μm or less. The tank for the filtered wastewater may be used, for example, to neutralize the wastewater before the flotation stage by adding CO₂ and/or acid. Likewise, volume buffering for optimal operation of the flotation stage may be performed therein.

In another favorable embodiment, the described system further includes a rainwater tank for collecting and admixing rainwater to the wastewater of the wet mill and washing system and/or to the circulating water. This allows reduction of the need for the supply of external fresh water from a mains network while maintaining a correspondingly good water quality.

The washing system includes, for example, at least three cleaning stages for pre-cleaning, main cleaning and post-cleaning, as well as an internal process water circuit for passing the second process water therein through the cleaning stage in counter-current to the comminuted waste plastic. Thus, the water quality generated in the second circulation circuit may be optimally used for stepwise cleaning of the material to be ground (comminuted waste plastic).

The wet mill includes, for example, a grinding chamber with grinding/cutting tools for comminuting the waste plastic with admixture of the first process water and a pre-washing stage for pre-washing the ground material (comminuted waste plastic) with the first process water in order to pick up dirt from the waste plastic in the first process water and to discharge the first process water thereafter, in particular substantially completely as waste water. This enables efficient comminution of the waste plastic and its equally efficient pre-washing. The pre-washing stage may be integrated into the grinding chamber of the wet mill.

Preferably, the system further includes a wastewater cleaning stage for the chemical

and/or enzymatic degradation of minute particles of plastic contained in the circulating water and for the partial discharge of circulating water cleaned in this way as wastewater, which is separated from the second portion of the circulating water, in particular by additional membrane filtration, electrocoagulation and/or reverse osmosis. In this way, the loading of the wastewater to be discharged with microplastics may be reduced.

### BRIEF DESCRIPTION OF THE FIGURE

A preferred embodiment of the disclosure is shown by drawing. The single FIGURE shows a flow diagram of the described system according to a preferred embodiment.

### DETAILED DESCRIPTION

As the FIGURE indicates, the system 1 for comminuting and cleaning waste plastic 2 includes a wet mill 3 for comminuting and pre-washing the waste plastic 2 and a preferably multi-stage washing system 4 for subsequent resource-preserving cleaning of the comminuted waste plastic 2.1 (ground material). Accordingly, the washing system 4 includes, for example, a first cleaning stage 4a for pre-cleaning, a second cleaning stage 4b for main cleaning and a third cleaning stage 4c for post-cleaning of the waste plastic 2.1 (ground material) that has been comminuted and pre-washed in the wet mill 3.

The system 1 further includes at least one mechanical filtration stage 5 and a flotation stage 6 for treating first wastewater 7 from the wet mill 3 and second wastewater 8 from the washing system 4, respectively, to form a circulating water 9 that may be reused at least in part in the system 1.

The system 1 further includes a buffer tank 10 for intermediate storage of the circulating water 9 and, connected thereto on the outlet side in each case, a first circulation circuit 11 for returning a first portion 9a of the circulating water 9 to the wet mill 3 and a second circulation circuit 12 for returning a second portion 9b of the circulating water 9 to the washing system 4.

The first portion 9a of the circulating water 9 is reused in the wet mill 3 as first process water 13, and the second portion 9b of the circulating water 9 is reused in the washing system 4 as second process water 14.

The first process water 13 is used in the wet mill 3 to cool its cutting/grinding tools (not shown) and to support the comminution of the fed waste plastic 2, for example to minimize grinding dust. Furthermore, the first process water 13 serves to absorb a portion of the contaminant load introduced by the waste plastic 2, in particular the main portion of the contaminant load, quantified for example in the form of the chemical oxygen demand (COD) and/or the solids content, relative to the total contaminant load introduced by the waste plastic 2.

For this purpose, the first process water 13 is passed through the wet mill 3 in a schematically indicated process water circuit and is discharged with the absorbed contaminant load as the first waste water 7 and fed to the mechanical filtration stage 5.

The second process water 14 is fed in the washing system 4, preferably in counter-current to the comminuted waste plastic 2.1 (ground material). For this purpose, the second process water 14 is first fed to the third cleaning stage 4c (secondary cleaning), then flows through the second cleaning stage 4b (main cleaning) and finally through the first cleaning stage 4a (pre-cleaning). In the process, the second process water successively picks up a dirt load and is finally discharged as second wastewater 8 and fed to the mechanical filtration stage 5.

Depending on the required quality of the second process water 14, the second circulation circuit 12 optionally includes a membrane bioreactor 15 or an electrocoagulation stage 16 for post-cleaning, thereby reducing the chemical oxygen demand, solids content and/or content of fats, oils and similar lubricants in the second portion 9b of the circulating water 9.

In the membrane bioreactor 15, organic components of the circulating water 9 and contained inorganic nutrients, such as nitrogen and phosphorus compounds, are converted into biomass (sludge) by preferably aerobic biological degradation in a tank 15a in a manner that is known in principle. In addition, a separate ultrafiltration stage 15b is preferably provided in the membrane bioreactor 15 in order, for example, to remove microplastics and/or to reduce the chemical oxygen demand, the biochemical oxygen demand and/or the nitrogen content in the second portion 9b of the circulating water 9 particularly effectively.

Instead of the membrane bioreactor 15, an electrocoagulation stage 16 may be used in particular if the requirements on the quality of the second process water 14 are lower and/or the circulating water 9 has only a comparatively low content of oils, fats and similar lubricants.

If a particularly high quality/purity is required for the second process water 14, for example for washing shredded waste plastic 2.1 for subsequent reuse in the field of food production, the second circulation circuit 12 may further include an optional reverse osmosis stage 17 connected downstream of the membrane bioreactor 15 or the electrocoagulation stage 16. This allows essentially fresh water quality to be achieved in the second portion 9b of the circulating water 9.

In order to adjust the volumetric flows of the first portion 9a of the circulating water 9 returned to the wet mill 3 and of the second portion 9b of the circulating water 9 returned to the washing system 4, the first circulating circuit 11 includes a first pump 18 and the second circulating circuit 12 includes a second pump 19. For this purpose, the pumps 18, 19 may be controlled/regulated independently of each other by means of at least one electronic control unit (not shown).

In this way, the first portion 9a (in particular its volume flow) is preferably set at least twice, in particular at least three to six times, as large as the second portion 9b (in particular its volume flow).

If necessary, additional actuating elements and/or pumps (not shown) are provided in the circulation circuits 11, 12 in order to adjust the volume flows of the first and second portions 9a, 9b of the circulating water 9 and/or to convey the latter between and in the individual described treatment stages in a manner that is basically known.

Fresh water 20 is preferably further supplied to the washing system 4 in order to compensate for water losses in the wet mill 3 and/or in the washing system 4 and/or during the described treatment of the waste water 7, 8 and/or the post-cleaning of the circulating water 9. Such water losses may be caused, for example, by evaporation or by the application of residual moisture in the individual treatment stages.

The requirement for fresh water 20 of the system 1 as a whole, however, may be significantly reduced compared to conventional systems for shredding and cleaning used plastic 2. Accordingly, the ratio of the second portion of the circulating water 9 supplied to the washing system 4 and the external fresh water may be set to at least 1 and in particular to 1.5 to 5.

The wet mill 3 may be supplied exclusively with the first portion 9a of the circulating water 9 to provide the first process water 13 required therein without an external fresh water supply. In contrast, the second process water 14 in the washing system 4 may be composed of the supplied second portion 9b of the circulating water 9 and the externally supplied fresh water 20.

The chemical oxygen demand in the first portion of the circulating water 9 may be, for example, 2 to 4 g/l without limiting the use of the circulating water 9 as the first process water 13 in the wet mill 3. In contrast, the chemical oxygen demand in the second portion 9b of the circulating water 9 is preferably at least halved, for example reduced to less than 1 to 2 g/l, by the post-cleaning at least in the membrane bioreactor 15 or the electrocoagulation stage 16 provided instead, in order to meet the often higher quality requirements when cleaning the comminuted waste plastic 2.1 in the washing system 4.

Further schematically indicated in the FIGURE is a waste water tank 21, which is arranged between the mechanical filtration stage 5 and the flotation stage 6 and may serve, for example, for volumetric buffering of the waste water 7, 8 to be cleaned and for setting a suitable pH value for the subsequent flotation treatment.

It is further indicated schematically that the mechanical filtration stage 5 may include, for example, a mechanical filtration unit 5a operating, for example, on the principle of a cyclone, and a fine screen 5b having, for example, a mesh size of at most 200 μm.

It is further indicated that the flotation stage 6 includes a decanter 22 preferably with a centrifuge and/or screw press, each of which dewaters the sludge 23 decanted in the flotation stage 6 so that it may subsequently be disposed of separately.

In a corresponding manner, it is schematically indicated that sludge 23 is likewise discharged from the membrane bioreactor 15, as is wastewater 24 produced therein. Wastewater 24 is also produced in the optionally provided reverse osmosis stage 17 during operation and is finally discharged.

The FIGURE also shows schematically that sand 25 and other solids 26 are separated and discharged in the mechanical filtration stage 5.

For the sake of completeness, it is further indicated that the waste plastic 2.2 (finished washed ground material) cleaned in the washing system 4 is finally dried in a dryer 27 and then provided as recyclate 2.3 of the described process for further processing, for example, for extrusion into pellets.

The system 1 may further include a rainwater tank 28 for adding rainwater to the wastewater 7, 8 and/or to the circulating water 9, if necessary also to its portions 9a, 9b separately. In this way, the fresh water requirement may be additionally minimized.

The system 1 described may be operated, for example, as follows.

The first process water 13 provided in the form of the first portion 9a of the circulating water 9 continuously flows through the wet mill 3 used for comminuting the waste plastic 2. This provides an internal process water circuit in the wet mill 3, which takes up the predominant portion, i.e. at least 50%, of the contaminants introduced by the waste plastic 9. The resulting first wastewater 7, together with the second wastewater 8 coming from the washing unit 4, is passed through the mechanical filtration stage 5 with the mechanical filtration unit 5a and the fine screen 5b, whereby sand 25 and other solids 26 are discharged.

Subsequently, the accordingly mechanically treated wastewater 7, 8 is fed to the wastewater tank 21, where it is temporarily stored and neutralized, for example. From there, the treated wastewater 7, 8 is fed to the flotation stage 6, in which remaining dirt particles are bound and separated with the aid of flocculants in a manner that is basically known. The resulting sludge 23 is centrifuged and/or pressed after decantation, thereby dewatered and finally disposed of separately.

The first and second wastewater 7, 8 are thus treated to form circulating water 9 in a first treatment stage formed by the mechanical filtration stage 5 and the flotation stage 6, which is obligatory for the method, and then temporarily stored in the buffer tank 10.

Starting from this, the circulating water 9 is divided in the form of a first partial flow into the first portion 9a for reuse in the wet mill 3 and in the form of a second partial flow into the second portion 9b for reuse in the washing system 4. These partial flows are adjusted, for example, by means of the separately controlled pumps 18, 19, and during system operation are preferably continuously adapted to the respective demand in the wet mill 3 for the first process water 13 and in the washing system 4 for the second process water 14.

Depending on the required water quality, the second portion 9b of the circulating water 9 is preferably post-cleaned in a second treatment stage formed either by a membrane bioreactor 15 or an electrocoagulation stage 16. The resulting sludge 23 may in turn be dewatered in a manner known in principle and disposed of separately.

Optionally, depending on the required water quality, the second portion 9b of the circulating water is additionally cleaned, in particular to fresh water quality, in a third treatment stage in the form of a reverse osmosis stage 17.

The second portion 9b of the circulating water 9 is thus cleaned at least in the first treatment stage with its mechanical filtration stage 5 and flotation stage 6, optionally further in the second treatment stage formed by the membrane bioreactor 15 or the electrocoagulation stage 16, and then optionally additionally in the third treatment stage formed by the reverse osmosis stage 17. For the first portion 9a of the circulating water 9, on the other hand, cleaning in the first treatment stage is usually sufficient.

The circulation circuits 11, 12 thus are separately controllable and treatable closed water circuits for supplying the wet mill 3 and the washing system 4. Water losses caused in the water circuits by the discharged sludge 23, evaporation and residual moisture of the cleaned used plastic 2 are compensated by adding external fresh water 20.

This additional fresh water requirement is reduced compared to conventional systems for comminution and cleaning of waste plastics 2, as is the degree of contamination and the quantity of waste water to be disposed of, so that the described method and the described system 1 enable a particularly environmentally friendly and economical reprocessing of waste plastics 2. For this purpose, the optional second and third treatment stages may be integrated depending on the required quality of the second process water 14 and/or depending on the waste water quality to be achieved. This may depend, for example, on the intended reuse of the recyclate 2.3, such as for the production of foodstuffs, and/or on the respective disposal costs for waste water 24.

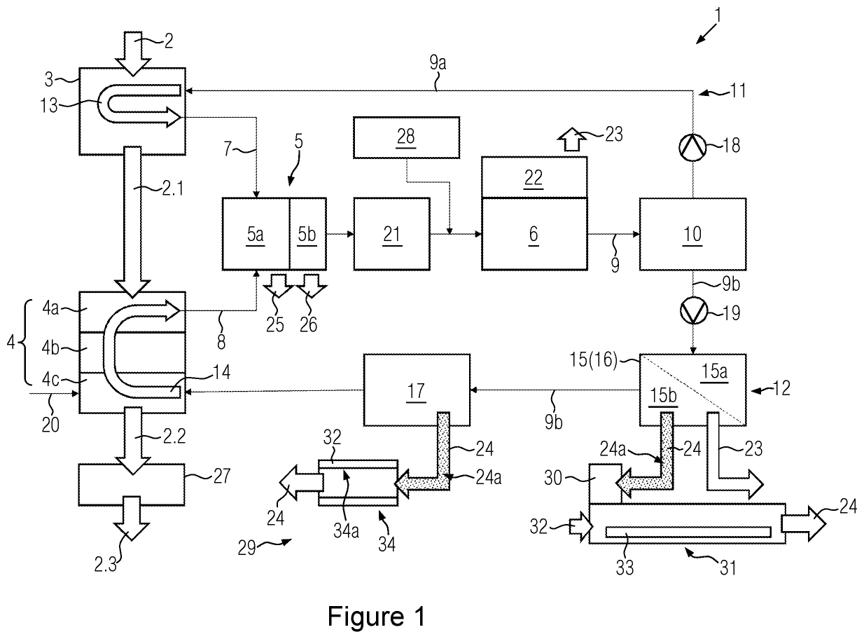

FIG. 1 further indicates an optional wastewater treatment stage 29 for chemical and/or enzymatic cleaning of the wastewater 24 to be discharged from the system 1 or the method. Accordingly, the waste water 7, 8 of the wet mill 3 and of the washing system 4, which is cleaned mechanically in the filtration stage 5 and in the decanter 22 of the flotation stage 6, i.e. the circulating water 9 resulting therefrom, is additionally treated enzymatically and/or chemically in order to reduce the loading of the waste water 24 with minute particles 24a of plastic, in particular of PET. For this purpose, the microparticles 24a are biocatalytically depolymerized by means of microbial polyester dehydrolases, for example. This is particularly effective if the microparticles 24a have a maximum particle size of 200 μm. Thus, the loading of the wastewater 24 with so-called microplastics may be efficiently reduced.

Depending on the configuration stage of the system 1, this chemical and/or enzymatic wastewater treatment is in principle possible at any point downstream of the mechanical filtration stage 5 and the flotation stage 6, for example in the first and/or second circulation circuit 11, 12, in particular in the wastewater effluent of the membrane bioreactor 15 or the electrocoagulation stage 16 and/or the reverse osmosis stage 17.

An enzymatic and/or chemical degradation of plastic, in particular PET, in the sense of depolymerization is particularly efficient after mechanical pre-cleaning, for example after filtration with mesh sizes of at most 200 μm, since the smallest particles 24a remaining thereafter (for example in the filtrate) allow relatively short diffusion paths for enzymatic/chemical reactions and have relatively large specific surfaces.

The associated mechanical pre-cleaning of the wastewater 24 to be discharged is feasible, for example, by means of the described mechanical filtration stage 5 and/or flotation stage 6 or decanter 22.

An additional mechanical pretreatment stage 30 for the wastewater 24, however, is in principle also conceivable, for example in each case in the wastewater discharge after sedimentation, flotation, filtration and/or electrocoagulation. Subsequent chemical/enzymatic degradation of the remaining microparticles 24a may then be performed, for example, in a (schematically indicated) secondary clarifier 31.

For this purpose, depending on the reaction system, an enzymatic catalyst 32 may be added to the wastewater 24 or also provided immobilized on a carrier 33 to be separated again later. Also conceivable is a reactor 34 through which the wastewater 24 flows and on whose functional surface 34a the enzymatic catalyst 32 is immobilized.

For the sake of clarity, these different variants of the wastewater cleaning stage 29 are shown side by side and are associated with the membrane bioreactor 15 or the electrocoagulation stage 16 and the reverse osmosis stage 17 only by way of example. For example, depending on the quality of the circulating water 9, the pre-treatment stage 30 may be omitted and/or only the secondary clarifier 31 or the reactor 34 may be present.

The described chemical and/or enzymatic cleaning of the wastewater 24 may be carried out as a continuous process or as a discontinuous process (batch process) in the wastewater treatment stage 29.

In order to optimize the reaction rate, the wastewater 24 may be heated to a temperature level that is optimal for the respective chemical/enzymatic reaction or for the catalyst 32. Waste heat from the described recycling process may be used for this purpose.

Alternatively or additionally, the reaction time available for the chemical/enzymatic wastewater treatment in each case may be increased by suitable residence time of the wastewater 24 in the secondary clarifier 31 or similar secondary reaction tank. This may also be combined with a settling tank, for example. It may also be an option to utilize the enzymatic degradation that may be progressing further in the settling sludge produced there, depending on the catalyst system.

Depending on the enzymatic catalyst system, the catalyst 32 may remain immobilized in the wastewater treatment stage 29, be separated and recycled after the chemical/enzymatic reaction, be separated and disposed of after the respective reaction, or also be disposed of together with the wastewater 24 (if it is safe to do so).

With the wastewater treatment stage 29, the loading of the wastewater 24 to be discharged with microplastics may be minimized particularly efficiently in combination with the described mechanical pre-treatment (filtering, decanting).

1. Method for comminuting and cleaning waste plastic, wherein the latter is comminuted and pre-washed in a wet mill and then cleaned in a washing system, wherein wastewater is subjected to mechanical filtration and flotation and then temporarily stored as circulating water, and a first portion of the circulating water is then fed back to the wet mill as first process water and a second portion of the circulating water is fed back to the washing system as second process water.

2. Method according to claim 1, wherein the second portion of the circulating water is post-cleaned by a combination of biodegradation and membrane filtration or by electrocoagulation.

3. Method according to claim 2, wherein the second portion of the circulating water is further post-cleaned by reverse osmosis to a quality suitable for food processing.

4. Method according to claim 1, wherein the first portion of the circulating water is adjusted to at least twice the quantity of the second portion.

5. Method according to claim 1, wherein external fresh water is further supplied to the washing system and a ratio of the supplied second process water and the external fresh water is set to at least 1.

6. Method according to claim 1, wherein a chemical oxygen demand (COD) in the second portion of the circulating water is reduced by the post-cleaning compared to the first portion of the circulating water by at least half.

7. Method according to claim 1, wherein cutting/grinding tools and the waste plastic comminuted therewith are exposed to the first process water in the wet mill, the latter thereby takes up a proportion of a contaminant load present on the waste plastic.

8. Method according to claim 1, wherein the circulating water, which has been mechanically cleaned by filtration and flotation and decantation, is treated proportionally chemically and/or enzymatically, thereby breaking down minute particles of plastic contained in the circulating water, and is discharged as waste water.

9. System for comminuting and cleaning waste plastic, comprising: a wet mill for comminuting and pre-washing the waste plastic; a washing system, for subsequent resource-preserving cleaning of the comminuted waste plastic; a mechanical filtration stage and a flotation stage for treating wastewater from the wet mill and the washing system to form circulating water; a buffer tank for intermediate storage of circulation water; and in each case connected thereto: a first circulation circuit for returning a first portion of the circulating water to the wet mill for use there as first process water, and a second circulation circuit for returning a second portion of the circulating water to the washing system for use there as second process water.

10. System according to claim 9, wherein the second circulation circuit comprises a one of a membrane bioreactor and an electrocoagulation stage and further comprises a respective downstream reverse osmosis stage.

11. System according to claim 9, wherein circulation circuits are connected to the buffer tank and configured to convey the circulating water so as to enable setting its first portion to be at least twice as large as its second portion.

12. System according to claim 10, wherein the membrane bioreactor comprises an aerobic biodegradation stage and a separate ultrafiltration stage.

13. System according to claim 9, wherein the mechanical filtration stage comprises a sand separator and a fine screen and/or is connected upstream of a tank for filtered wastewater.

14. System according to claim 9, further comprising a rainwater tank for collecting and admixing rainwater to the wastewater and/or circulating water.

15. System according to claim 9, wherein the washing system comprises at least three cleaning stages for pre-cleaning, main cleaning and post-cleaning, as well as an internal process water circuit for passing the second process water therein through the cleaning stages in counter-current to the comminuted waste plastic.

16. System according to claim 9, wherein the wet mill comprises a grinding chamber with cutting tools for comminuting the waste plastic with admixture of the first process water and a pre-washing stage for pre-washing the comminuted waste plastic with the first process water in order to take up a contaminant load of the waste plastic in the first process water and then to discharge the first process water as waste water.

17. System according to claim 9, further comprising a wastewater cleaning stage for chemical and/or enzymatic degradation of minute particles of plastic contained in the circulating water and for proportionally discharging circulating water thus cleaned as wastewater that is separated from the second portion of the circulating water.

18. Method according to claim 1, wherein cleaning in the washing system includes in a multistage resource-preserving washing system.

19. Method according to claim 7, wherein the latter thereby takes up a main proportion of the contaminant load present on the waste plastic, and is then fed completely as waste water to mechanical filtration and flotation.

20. System according to claim 17 wherein the separating is by additional membrane filtration, electrocoagulation and/or reverse osmosis.
